(19) United States
(12) Patent Application Publication
(10) Pub. No.: US 2008/0004844 A1
(43) Pub. Date: Jan. 3, 2008

(54) Method and System for Estimating Project Costs

(76) Inventors: Mark Kefford, Toowong (AU); Simon William Lovegrove, Queensland (AU); Jason Anderssen, Queensland (AU)

Correspondence Address: HOFFMANN & BARON, LLP, 6900 JERICHO TURNPIKE, SYOSSET, NY, 11791, US

(21) Appl. No.: 11/663,261

(22) PCT Filed: Sep. 27, 2005
(86) PCT No.: PCT/AU05/01484

§ 371 Date: Mar. 20, 2007

(30) Foreign Application Priority Data
Sep. 27, 2004 (AU) 2004905547

(51) Int. Cl. G06F 17/00

(52) U.S. Cl. 703/1; 705/10; 705/20

(57) ABSTRACT

A method of estimating project costs is disclosed. Geometric information is extracted from a design plan for the project and a cost estimate for the project is automatically generated using the geometric information extracted from the design plan and a computerized cost data store that contains cost estimates for the extracted geometric information. Either during the project, or after the project has been completed, actual cost data relating to the geometric information is electronically received and this actual cost data is used to update the computerized cost data store.

### FIELD OF THE INVENTION

The invention relates to a method and system for estimating project costs. In particular, although not exclusively, the invention relates to estimating costs in relation to construction industry projects. In a further form, the invention relates to a method and system for estimating cost changes during successive iterations of construction plans.

### BACKGROUND TO THE INVENTION

The accurate estimation of costs during large-scale building and civil engineering projects is vital in order that project budgets can be well scoped and managed. Additionally, it is important for construction companies to accurately estimate costs in order to tender for projects and to re-calculate these costs as the scope of the project changes in order to recover the cost of changes under commercial contracts.

The total cost for a construction project includes such items as cost for labour, equipment, materials, etc. The cost of materials and labour have been inherently linked to the geometric properties of a building and may be calculated using cost estimation handbooks which are well known in the industry.

These cost guides allow costs to be calculated based on the provision of building design geometry such as room sizes, floor plate areas, etc. These costs are calculated using analysed historical data for a particular building type (i.e. large commercial, medium commercial, etc) applied to the cost geometry of the new design. Hence, in order to estimate these costs it is necessary to manually measure the geometry of the building such as the area of the floor plans, the number of rooms and the area of each room as well as a number of other factors such as the number of designated items (such as air conditioning vents) per floor. These measurements are then compiled and the cost is estimated by application of analysed cost data using the cost guide or a cost library.

It is recognised in the industry that software packages can assist in this cost estimation process. Most available estimating packages rely on the keyed input of individual dimensions derived from the sight measurement of drawings using scale rulers. More recently, a number of software packages have added a digitising capability which electronically traces over prints of the design drawings. Some packages allow electronic images of the design drawings to be digitised on screen. One such product available is the Buildsoft package, a description of which can be found at www.buildsoft.com.au. Buildsoft is a direct simulation of the manual process of estimation described above. An image of a plan is provided to the package and an operator manually traces the image of the plan displayed on the screen. Buildsoft then electronically measures the dimensions of this image and calculates the area upon the provision of an appropriate scale.

For example, a room is manually traced on a plan shown on a computer screen and the package calculates the area of the room as well as the dimensions based on this trace. This information is then broken down manually into sub-elements, such as linear metres of walls, windows, number of doors and the like. The cost of each of these sub-elements is then extracted from a database and then the total cost is calculated. Generally, this database is a digitised cost guide with the cost of each sub-element being entered into the database by an operator.

Plans for buildings are developed using computer aided design (CAD) packages. A common feature of the current generation design packages is that they allow draftsmen to build up complex re-useable objects from low-level geometric objects such as arcs, lines (etc). These complex objects are referred to as blocks.

A drawing file (for example a *.dwg Autocad® drawing file) is basically a database of vector co-ordinates that provides an identifier for each low-level object, an indication as to what type of object it is and information relating to the geometric properties of each object. This information is then used by the drawing package to render the vector database graphically for the user. For example, a drawing file that has a single line, which perhaps may represent a wall in a building, will have a single entry in it's vector co-ordinates database as represented below:

TABLE 1

| IDENTIFIER | OBJECT TYPE | ATTRIBUTES |
|---|---|---|
| 1 | Line | Start Co-ordinates: (2, 3) |
| | | End Co-ordinates: (5, 7) |

It will be appreciated by a skilled person that different CAD packages will represent this information in different manners. However, the fundamental principle will be the same for all CAD packages that use vector database file types to persistently store an electronic drawing. That is, all provide the software package with an identifier for each object, an indication of what the object type is and attributes of that object so that each object may be rendered.

As previously mentioned, CAD packages allow draftsmen to create and store more complex objects from low-level geometric objects. For example, a draftsmen working on the floor design of a building may need to draw several air conditioning vents per floor. Rather than re-drawing the air conditioning vent each time, the draftsman can create an air conditioning vent block that can be reused. In order to do this, the draftsman creates the air conditioning vent from low-level objects such as lines, etc. The air conditioning vent block is then saved as a block and can be re-used throughout the drawing.

Importantly, in the vector co-ordinate database, every instance of the air conditioning vent object that is located in the drawing will appear in the database as a reference to the air conditioning vent object. The block object is located in a separate database that is known in the art as a block table. For example, if an air conditioning vent was added to the drawing file shown in Table 1, the table would have an additional entry as indicated in Table 2 shown below.

TABLE 2

| IDENTIFIER | OBJECT TYPE | ATTRIBUTES |
|---|---|---|
| 1 | Line | Start Co-ordinates: (2, 3) |
| | | End Co-ordinates: (5, 7) |
| 2 | Block | Block Identifier: 3 |
| | | Displacement:: (10, 10) |
| | | Orientation: 0° |

Hence, a reference to the air conditioning vent object is shown in the vector database as a reference to block identifier 3 in the block table. The block table for the air conditioning vent used in this example is shown in Table 2A below.

TABLE 2A
Block Identifier: 3

| IDENTIFIER | OBJECT TYPE | ATTRIBUTES |
|---|---|---|
| 4 | Line | Start Co-ordinates: (10, 0) |
| | | End Co-ordinates: (10, 10) |
| 5 | Line | Start Co-ordinates: (10, 10) |
| | | End Co-ordinates: (20, 10) |
| 6 | Line | Start Co-ordinates: (20, 10) |
| | | End Co-ordinates: (20, 0) |
| 7 | Line | Start Co-ordinates: (20, 0) |
| | | End Co-ordinates: (10, 0) |

When the CAD package renders this drawing, the software retrieves the definition of the air conditioning vent from the block table (i.e. represented by Table 2A) and renders this object based on its' attributes. A block object may itself contain a reference to a further block object.

It will be appreciated that the attribute list for each object may contain different information for different object types. Additionally, the information in the attribute list for a more complex object is not limited to geometric attributes and may include part numbers, costs and the like.

It is a known method in the art of project cost estimation to identify objects directly from the vector co-ordinate database of the electronic drawing file in order to track changes between iterations of a drawing. One such package is Bang, which was developed to work with Autocad®. Bang identifies basic objects directly from the identifier in the vector co-ordinate database of the drawing file and uses the calculations provided by Autocad® in order to generate cost estimates in conjunction with a cost database.

However, Bang is deficient in tracking changes between successive iterations of drawing files. This is due to the fact that Bang only identifies the top level object. In the example shown above, Bang would only store the identifier 2 to identify the block. Hence, Bang does not have the capacity to identify when a line within a block is moved or deleted between drawing files as it is not able to uniquely identify each basic element in a drawing file. Therefore, it is not possible to calculate the change in costs as the scope of the project changes.

This problem is further compounded when drawing files contain references to other drawing files. These references are known in Autocad® as Xrefs. In this case, prior art packages create their own identifiers for all referenced objects when objects in the drawing file are being identified. As such, there exists no linkage between the identifiers created between successive iterations of drawing files. As such, scope change cannot be accurately calculated between successive drawing files that have Xrefs.

A further problem with the above mentioned prior art cost estimation solutions is that the cost database used to generate the cost estimates from the geometric properties of the buildings are subject to error over time. The costs of building projects vary as material and labor costs vary over time. Furthermore, the costs of building projects are different between countries and indeed regions within a single country. As such, the above cost estimation methods are deficient as they do not take into account the fluctuation on construction costs over time nor do they conveniently accommodate for the variation in construction costs between geographical regions.

For these reasons, it is desirable to provide a more sophisticated method for estimating construction costs for commercial building projects and the like.

### OBJECT OF THE INVENTION

An object of the invention is to overcome or at least alleviate one or more of the above problems and/or provide the consumer with a useful or commercial choice.

### DISCLOSURE OF THE INVENTION

In one form, although it need not be the only or indeed the broadest form, the invention resides in a method of estimating project costs, said method including the steps of:

(i) electronically extracting geometric information from a design plan for said project, said geometric information being formed from one or more elemental building objects with each said elemental building object having one or more associated attributes;

(ii) automatically generating a cost estimate for construction of said design plan using a computerized cost data store containing estimated costs for each said elemental building object electronically extracted in step (i);

(iii) electronically receiving actual cost data relating to each said elemental building object; and

(iv) automatically updating said computerized cost data store based on said actual cost data electronically received.

In a further form, the invention resides in a system for estimating project costs comprising:

an extraction system for electronically extracting elemental building objects from geometric objects in a design plan; and
an estimation module in communication with said extraction system, said estimation module having:
   a computerized cost data store containing cost estimates for each said elemental building object;

wherein, said estimation module automatically provides a cost estimate of said project based on said cost estimates stored in said computerized cost data store of each said elemental building object extracted by said extraction system, and wherein said cost estimates stored in said computerized cost data store in said estimation module is updated upon receipt of actual costs for each said elemental building object.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows a system for estimating costs according to an embodiment of the present invention;

FIG. 2 shows a method for estimating costs according to an embodiment of the present invention;

FIG. 3 shows an extraction system forming part of the system shown in FIG. 1;

FIG. 4 shows a method of estimating project costs according to a further embodiment of the present invention;

FIG. 5 shows a method of uniquely identifying an object in an electronic drawing file forming part of the method shown in FIG. 4; and

FIG. 6 shows a method of calculating scope change according to a further embodiment of the present invention.

### DETAILED DESCRIPTION OF THE INVENTION

The method and system for estimating project costs provides for an iterative cost data store that uses actual cost data after the construction phase of a project has been completed in order to update the costs in the cost data store in order that subsequent cost estimates generated using the cost data store are more accurate and reflect recent trends in costs of materials and labor.

The method and system for estimating project costs is described below with reference to estimating the costs of constructing a commercial building. It will be appreciated the method and system of the present invention may be applied to other similar projects where the costs of materials and labor may be inferred from a plan of the physical thing which is to be constructed such as a dam, a mine, a tunnel or the like.

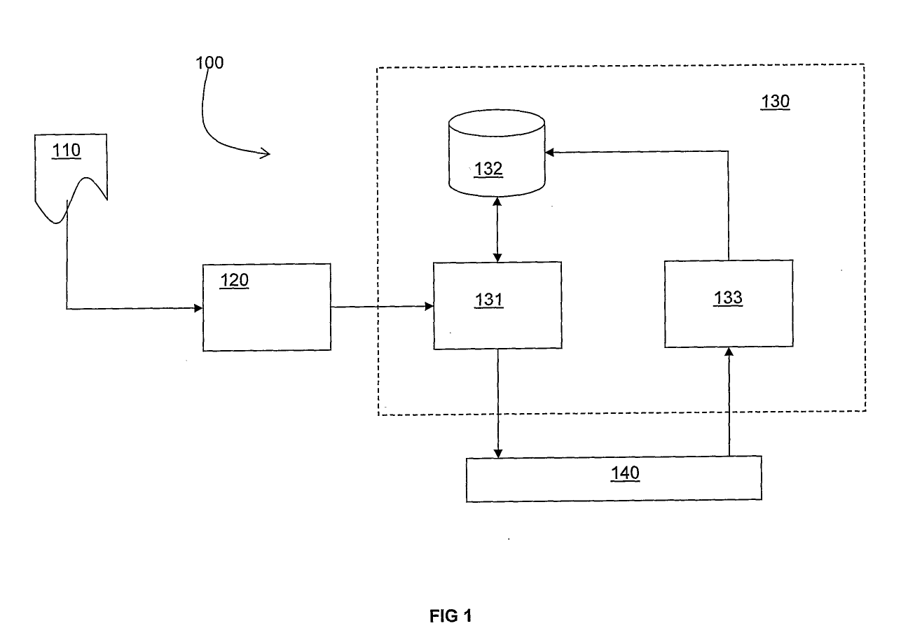

FIG. 1 shows a system 100 for estimating project costs according to an embodiment of the invention. System 100 comprises a drawing file 110, an extraction system 120, an estimation module 130 and a project entity 140.

Drawing file 110 is a plan of a building which is to be constructed as part of a construction project. Preferably, drawing file 110 is in the form of one or more electronic drawing files created by a computer aided design (CAD) package. Optionally, drawing file 110 is in the form of one or more physical drawing files which may be scanned and converted to an electronic drawing file.

Extraction system 120 is a software component that is able to interpret digital drawing file 110 and convert the geometric representations in the drawing file 110 into elemental building objects having attributes associated therewith. Extraction system 120 will be discussed in more detail below. Extraction system 120 is in data communication with estimation module 130.

Estimation module 130 has an estimate compilation sub-module 131, a cost data store 132 and a feedback sub-module 133. Estimate compilation sub-module 131 receives data from extraction system 120 and prepares a cost estimate for the construction project. Estimate compilation sub-module 131 is in communication with cost data store 132.

Cost data store 132 is in the form of a relational database. Optionally, cost data store 132 may be a distributed database or any other form of electronic data store as is known in the art. Cost data store 132 has stored therein cost data for all elemental building objects necessary to construct a building including the cost of materials and labor. For example, the cost data store 132 may include such attributes as the cost per linear meter, including materials and labor, of a supporting wall or the cost per square meter of a concrete slab.

Feedback sub-module 133 also forms part of estimation module 130. Feedback sub-module 133 is in data communication with cost data store 132 and is able to update the construction costs stored in cost data store 132. Feedback sub-module 133 will be discussed in more detail below.

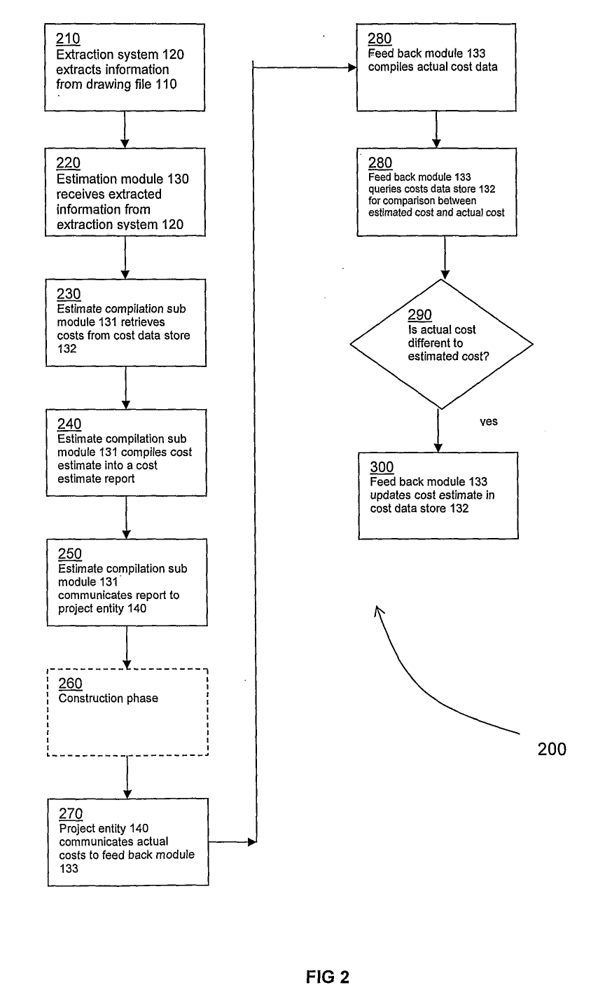

The elements of estimation module 130 discussed above are preferably embodied in a software program running on a computer system. As such, it will be appreciated that the elements shown in FIG. 2 are separated into functional characteristics of the software program. Optionally, each of estimate compilation sub-module 131, cost data store 132 and feedback sub-module 133 may be located on geographically separate computer systems in a manner well known in distributed computing with the interaction between each of the elements of estimation module 130 shown in FIG. 1 supported by a private or public network such as a local area network or the Internet.

System 100 further comprises project entity 140 in communication with estimation module 130. Preferably, project entity 140 is the entity responsible for construction of the commercial building. Project entity 140 will be discussed in more detail below.

FIG. 2 shows a method 200 of estimating costs according to a further embodiment of the present invention. The method 200 of the invention commences when drawing file 110 is provided to extraction system 120. As previously described, extraction system 120 is in the form of a known extraction software component as discussed above. Alternatively, extraction system 120 is able to uniquely identify and track each geometric object in drawing file 110 as will be discussed in greater detail below.

Optionally, extraction system 120 may be in the form of a human operator that performs measurements of the geometric properties of a physical drawing file and associates these geometric properties with attributes. For example, the human operator may measure the total plate area of a floor of the commercial building and associate this area with the attribute “plate area”. Hence, the elemental building object of the floor plate has as an attribute an area value. Additionally, extraction system 120 performs a count of all similar geometric objects, for example all air conditioning vents.

Hence, extraction system 120 interprets drawing file 110, extracts geometric information from this drawing file and communicates this information to estimation module 130 (steps 210 and 220). As previously discussed, this geometric information includes a classification of the elemental building object and at least one attribute of this object such as the area, number of units, etc. Preferably, the extracted information is communicated from extraction system 120 to estimation module 130 via a computer systems internal communication system. Alternatively, this information may be communicated via a network, such as the Internet, via e-mail or an appropriate data communication protocol, such as TCP/IP.

Estimate compilation sub-module 131 of estimation module 130 receives the geometric information extracted by extraction system 120 and communicates with cost data store 132 to obtain a cost estimate for each elemental building object received (step 230). For example, estimate compilation sub-module 131 receives information from extraction system 120 relating to the area of a floor. Estimate compilation sub-module 131 retrieves the cost per square meter for a commercial building floor and calculates the actual cost based on the area provided by extraction system 120 and stores the cost estimate for this component.

Estimate compilation sub-module 131 repeats this process for all data received from extraction system 120. When all the costs have been estimated, estimation compilation sub-module 131 compiles a cost estimate report (step 240) and communicates this report to project entity 140 (step 250). It will be appreciated that his cost estimate report may be displayable in different forms to suit the particular user or user type.

Preferably, the cost estimate report is displayable on a monitor of a computer system and also printable in order that project entity 140 may analyze the estimate. Optionally, the generated cost estimate report is communicated to project entity 140 via a data messaging system such as e-mail, facsimile or a network communications protocol such as TCP/IP.

The project entity 140 uses the cost estimate report received in step 250 in order to cost a construction project. The construction phase (step 260) then commences with the project entity constructing the commercial building for which the cost estimate report was generated. The construction phase does not constitute part of the invention. However, actual cost data for elemental building objects is produced during the construction phase and this data is used as will be discussed in greater detail below.

Additional cost estimate reports may be generated during the construction phase as the scope of the project changes due to changes in building design and other such changes. Change in construction costs due to changes in design, referred to as scope management, will be discussed in more detail below.

Once the construction phase has been completed and the project entity 140 has finalized the actual cost that was accrued in constructing the commercial building, the project entity 140 communicates the actual costs to feedback sub-module 133 of estimation module 130 (step 270).

The actual costs may be entered manually into feedback sub-module by a human operator. However, a skilled person will appreciate that many organizations utilize invoice management systems that enable the organization to digitally track all invoices. As such, actual cost data may be automatically communicated from a computerized invoice management system to feedback sub-module in step 270.

Optionally, the project entity 140 may communicate the actual costs of each elemental building type to feedback sub-module 133 of estimation module 130 (step 270) progressively during the construction project. For example, the project entity may receive an invoice for the supply and installation of air conditioning vents and may update the cost estimate stored in cost data store 132 prior to the completion of the building's construction.

The feedback sub-module 133 compiles the actual cost data (step 280) and breaks down this data into a format that is compatible with cost data store 132. For example, the project entity 140 may communicate to feedback sub-module 133 the actual cost accrued in materials and labor to construct a floor plate. The feedback sub-module 133 then breaks these costs down to an actual cost for this unit in terms of geometric properties (i.e. per square meter, per cubic meter, etc.).

The feedback sub-module 133 then queries the cost data store 132 to determine the current estimate stored in this data store for this elemental building object (step 280). If the estimated cost stored in the cost data store 132 differs from the cost of the elemental building object calculated by the feedback sub-module 133 (step 290), the feedback sub-module 133 updates the estimated cost in the cost data store 132 (step 300).

Preferably, when a cost estimate in cost data store 132 needs to be updated, feedback sub-module 133 averages the actual cost for the elemental building object with the estimate previously stored in cost data store 132 and stores this averaged value in cost data store 132 as the new estimate for that elemental building object.

Optionally, feedback sub-module 133 may update the cost estimate for each elemental building object in cost data store 132 when the actual cost differs from the estimated costs stored therein without averaging these values.

Alternatively, the feedback sub-module 133 may only update the cost estimate for an elemental building object in cost data store 132 when the actual cost differs from the estimated cost stored when these costs diverge by a certain tolerance (For example, when they differ by 5%).

The method and system of the present invention overcomes the disadvantages of the prior art methods of estimation as it provides for a dynamic cost data store that accommodates for fluctuations in instruction material and labor costs over time. Hence, the method and system of the present invention provides for a cost estimation method that is resilient to changes in price in order that project entities may obtain precise cost estimate data for a project for tendering and scope management purposes.

For example, a building project may have 20 air conditioning vents depicted in a drawing file that is a plan of the building. The details from this drawing file are extracted by an extraction module and communicated to the estimation module. The cost data store of the estimation module may have an estimate that each air conditioning vent will cost $2000 to purchase and install. Hence, for this unit, the cost estimation module will generate an estimate of $40000 to purchase and fit the air conditioning units. After these units have been installed, the project entity receives an invoice from the contractor responsible for installing the air conditioning vents. This invoice may total $50000, or a cost of $2500 per air conditioning vent. Hence, this data is communicated to the feedback sub-module of the estimation module and the cost data store is updated.

A further example is to consider a wall within a building project. As above, the dimensions of this elemental building object are extracted from the drawing file by an extraction module and communicated to the estimation module. Hence, the elemental building object, in this case a wall, has associated therewith the attribute, for example, 50 square meters, representing the size. Other attributes such as wall type, etc may similarly be associated with the object.

The cost data store of the estimation module contains an estimate of the cost of all the types of components that can be used to make up the wall such as, steel or timber framing, the plasterboard, the cornice, the skirting and the types of wall finish such as paint or tiles. These estimates are represented in the cost data store as costs per square meter. The cost estimation module then generates a cost estimate by combining all of these individual costs and selections from a user relating to quality and type and generating a cost estimate based on the area of the wall (in square meters). After the wall has been constructed the invoices from the suppliers and sub-contractors are communicated to the feed back sub-module in order that the cost estimates per square meter for the wall components may be updated for future projects. Hence, the cost estimates for components, for example a wall, may be calculated by combining many different cost estimates stored in the cost data store in order to arrive at the final estimate for the component.

According to a further aspect of the present invention, an extraction system 130 is provided to facilitate extraction of individual elements from a drawing file. This aspect of the invention overcomes deficiencies present in the prior art by identifying the hierarchy in which a basic drawing object exists in an electronic drawing file and uniquely identifying this object with regard to it's position in the hierarchy. In this way, it is possible to uniquely identify all elements in a drawing file and track changes between successive iterations of a drawing file. This facilitates the efficient and accurate calculation of cost estimates and allows for the management of cost changes as the scope of the project changes. This is referred to in the art as scope change.

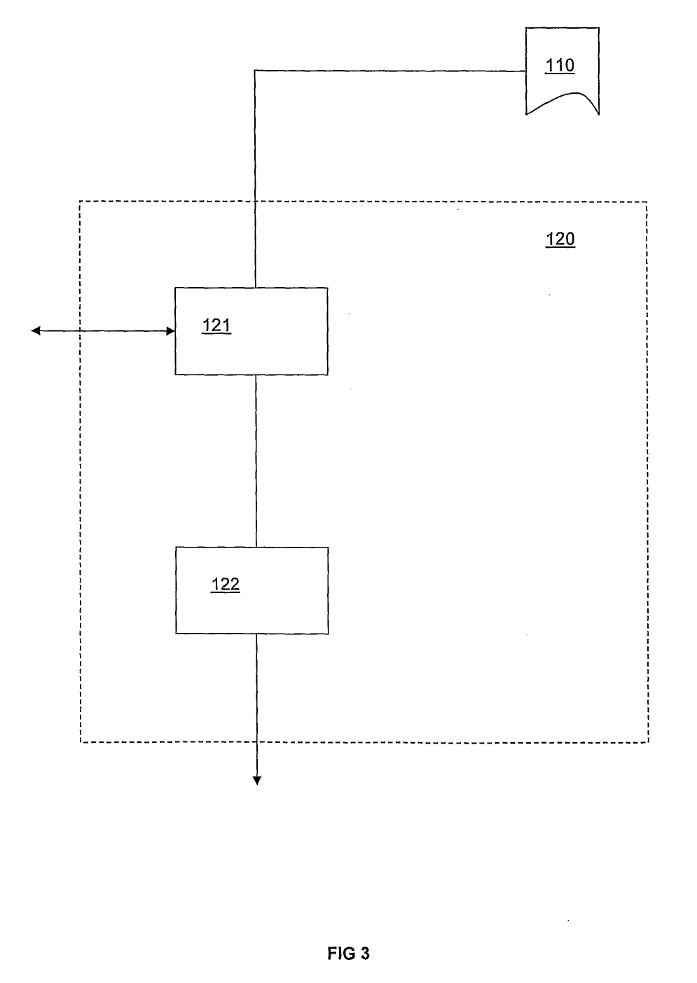

FIG. 3 shows an extraction system 120 according to a further aspect of the present invention. As shown in FIG. 1, extraction system 120 forms part of the system 100 for estimating project costs. Extraction system 120 comprises an extraction and processing module 121 and a reporting module 122. Also shown in FIG. 1 is a representation of electronic drawing file 110.

Extraction and processing module 121 enables a user of system 100 to interact with electronic drawing file 110. Extraction and processing module 121 uniquely labels each low-level geometric object that forms an elemental building object in the electronic drawing file 110 and stores these unique labels. Additionally, extraction and processing module 121 interacts with a user of system 100 in order to extract drawing objects from the plan provided in electronic drawing file 110. This process will be described in more detail below.

Reporting module 122 is in communication with processing and extraction module 121 and is further in communication with estimation module 130 as will be discussed in more detail below.

Preferably, the components of extraction system 120 described above are located on a single computing device. Optionally, the modules may exist in a distributed computing environment whereby the modules exist on physically separate computing devices with communication taking place via a communication network.

As previously discussed, electronic drawing file 110 is an electronic file generated by a CAD drawing package. Preferably, electronic drawing file 110 is a *.dwg file generated by AutoCad® and is in the form of a vector co-ordinates database that provides an identifier for each low-level object, an indication as to what type of object it is and information relating to the geometric properties of each object. Using this information, it is possible to render the vectors described in the drawing file. It will be appreciated that electronic drawing file 110 may be a drawing file generated by any known CAD package providing the CAD package stores the vectors that comprise the drawing in a vector-coordinate database as described above. Examples of such CAD packages include ArchiCad and Microstation.

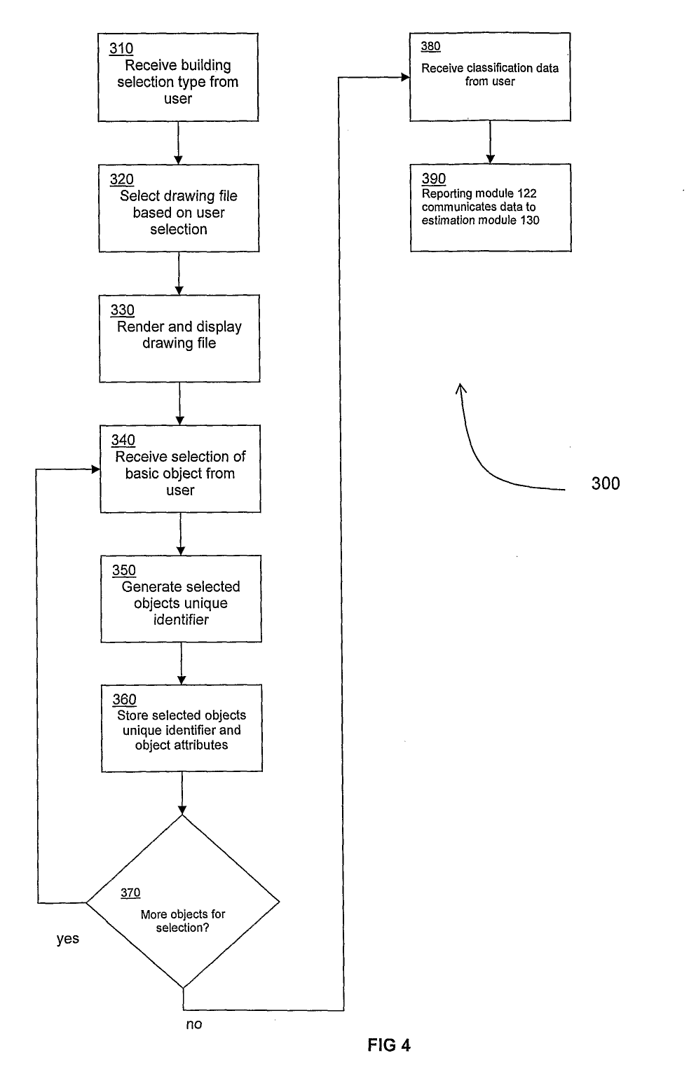

FIG. 4 shows a method of estimating project costs 300 according to a further embodiment of the invention. The method starts with extraction and processing module 121 receiving a building selection type from a user (Step 310). For example, a user may select that the current building type is a large commercial building. This selection is transmitted to the cost database 131 and specifies the type of cost information that is used when calculating the cost estimate. The selection is stored by the estimate compilation sub-module 131 of estimation module 130.

In step 320, the extraction and processing module 121 receives a selection of an electronic drawing file from the user. The selected file will be the file upon which the cost calculation takes place. The vector co-ordinate database of the drawing file is interpreted by the extraction and processing module 121 and is rendered for display on a display monitor (Step 330).

The extraction and processing module 121 then receives from the user a selection of a basic object, for example a line, from the rendered display of the electronic drawing file (Step 340). By selecting a basic object in step 340, the user is indicating to system 100 that the selected basic object should be included in the cost estimate.

Optionally, all basic objects may be automatically selected by the extraction and processing module 121 and hence all basic objects in the electronic drawing file will be used to estimate the construction costs.

In step 350, a unique label for the selected basic object is generated by the extraction and processing module 121. This step will be described in more detail below.

The unique label, generated in step 350, is stored by the extraction and processing module 121 in step 360. Additionally, the attributes relating to the basic object are stored along with the unique label generated in step 350.

Steps 340, 350 and 360 are repeated until the user indicates to the extraction and processing module 121 that no further objects are required for selection.

In step 380, each object is classified by the user according to what the object represents in terms of elemental building objects. For example, a line may represent an internal wall and, with the provision of how high the wall is, the processing and extraction module 121 can calculate the total wall area and associate this attribute with the wall elemental building object. Optionally, this information may be already present in the data file 110 by way of metadata or the like and this information is used by extraction module 121 to classify the object.

In step 390, the reporting module 122 communicates the elemental building types and attributes of each object classified in step 380 for the particular building type designated by the user in step 310 to estimate compilation sub-module 131 of estimation module 130.

The method of cost estimation then continues as described from step 220 in FIG. 2.

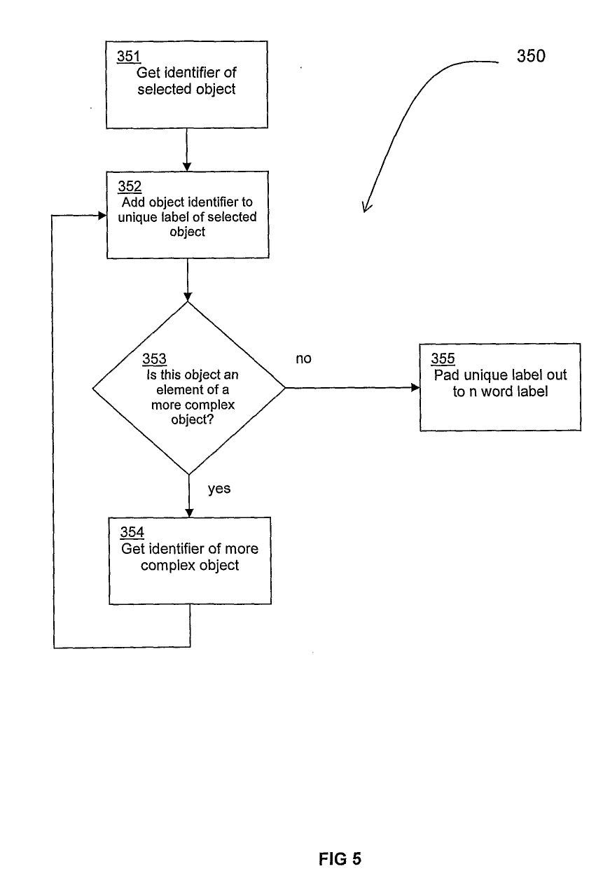

FIG. 5 shows a method of uniquely identifying an object in an electronic drawing file according to a further embodiment of the invention. The steps in the method shown in FIG. 3 are a more detailed description of step 350 in FIG. 4.

The identifier of the basic object is initially retrieved by the extraction and processing module 121 from the vector co-ordinates database (step 351) of the digital drawing file 110. This object identifier retrieved in step 351 is then stored as part of the unique object label for the selected object (step 352). If the identifier selected from the vector co-ordinates database in step 351 is part of a more complex block object (step 353), the block object identifier is then retrieved from the vector co-ordinates database (step 354) and is added to the unique object label of the selected object (step 352).

This process continues until the drawing level is reached. At this point, the unique label for the selected object is padded out to an n word unique label (step 355).

The unique label generated by the method shown in FIG. 5 is a sequence of n 32 bit integers. Preferably, the right most 32 bit word in the unique label is the identifier of the basic object and each subsequent non-zero 32 bit word to the left being an identifier of a more complex object of which the basic object forms a part. Hence, the unique label created has a right most significant word. Optionally, the method of the present invention may create a unique label having a left most significant word.

Preferably, the unique label has 8 32-bit integers. It will be appreciated that the unique label may be formed from any number of 32-bit integers with the number depending on space and processing requirements and the complexity of the electronic drawing file.

For example, in the example vector co-ordinates database shown in Table 2 and Table 2A discussed in the background section, if a user had selected the line having the identifier 4 in the air conditioning vent object, the method of the invention shown in FIG. 5 would create the unique label for this line as indicated below.

| | | | | | | | |
|---|---|---|---|---|---|---|---|
| 0 | 0 | 0 | 0 | 0 | 0 | 2 | 4 |

However, if a user had selected the single line indicated by the identifier 1 in Table 2, the method of the invention shown in FIG. 5 would create the unique label for this line as indicated below.

| | | | | | | | |
|---|---|---|---|---|---|---|---|
| 0 | 0 | 0 | 0 | 0 | 0 | 0 | 1 |

It will be appreciated that this instance of the air conditioning vent object may be part of a more complex block definition, for example a room. In this case, the least significant non-zero word (i.e left most non-zero word) of the unique label would contain a reference to the instance of the room object which this particular instance of the air conditioning vent object is located. Additionally, the left most non-zero word of a unique identifier may be an identifier of the drawing file 110. Hence, all basic objects within the same drawing file will have the same left most non-zero word.

Furthermore, in the case where drawing files contain Xrefs, the method of the present invention is able to uniquely identify basic objects within a referenced drawing file by storing these basic objects in a hierarchy with the left most non-zero word of the referenced drawing being an identifier for the referenced drawing.

The prior art methods described above do not have the capability to generate unique labels for objects within an electronic drawing file. As such, these methods would not be able to identify simple objects within more complex objects. The method of the present invention overcomes the deficiencies of prior art methods by generating unique object labels having regard to the hierarchy in which the object exists. By using this hierarchy to create a unique label for an object, all objects in an electronic drawing can be uniquely labeled.

As previously mentioned, by creating unique labels for all basic objects in an electronic data file it is possible to effectively and efficiently identify changes that have been made to a construction plan without having to rely on a persons' cognitive discrimination abilities.

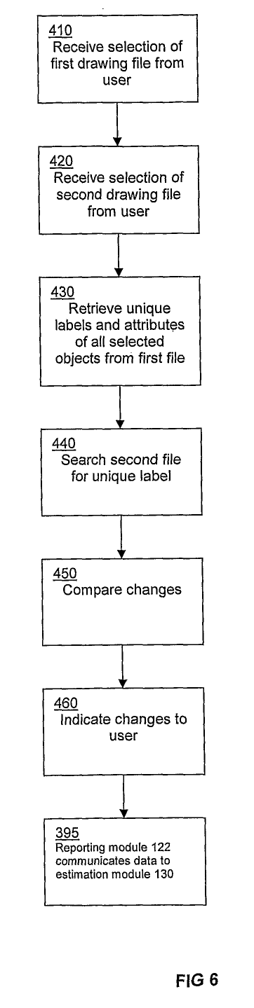

FIG. 6 shows a method 400 of calculating scope change between successive iterations of an electronic drawing file. In this way, as the scope of the project changes, it is possible to measure the corresponding change in construction costs.

The extraction and processing module 121 receives an indication from a user as to which first drawing file a second drawing file must be compared against (Step 410). The extraction and processing module 121 then receives a selection of the second electronic drawing file from the user (Step 420). The extraction and processing module 121 then retrieves the unique object labels and attributes stored for the first drawing file (step 430) and uses these unique object labels to search the vector co-ordinates database of the second drawing file (step 440).

The extraction and processing module 121 then compares any changes in step 450. For example, if an object, for instance a line, is not located in the second drawing file but is in the first drawing file then this is indicated to the user in step 460.

Furthermore, if the attributes of an object has changed, for example it may have been moved, then this is identified by the extraction and processing module 121 and also indicated to the user in step 460.

Optionally, if unique labels have been generated for all objects in the first drawing file, it is possible to indicate to the user in step 460 when a new object has been added in the second drawing file.

The indication of changes to the user in step 460 may be facilitated by employing a defined color screen when the second drawing is rendered. For example, a red line may indicate on the rendering of the second drawing that this line was present in the first drawing but not in the second. A blue line may indicate that a line was in the first drawing file but has been moved in the second drawing file.

Indications of this type provide for an efficient and effective indication to workers of design changes that have occurred to a building. Sometimes these changes may be subtle and may not be easily discernable with the naked eye. Hence, by providing an indication to a user of changes in design it is ensured that construction workers are alerted to the fact that differences exist between plans and the most recent plan is used during construction.

In step 395 in FIG. 4, a cost estimate for the second drawing file is generated in a similar manner as described in FIG. 2. Additionally, the estimation module 130 calculates the change in costs that have occurred between the drawing files.

The present invention is able to effectively and accurately identify and track changes between a first and a second drawing file wherein the second drawing file is an updated version of the first drawing file. This is facilitated by the process of generating unique labels for selected objects in a drawing file. In this way, scope change can be tracked and managed by construction companies in order that a project remains profitable.

Throughout the specification the aim has been to describe the invention without limiting the invention to any one embodiment or specific collection of features. Persons skilled in the relevant art may realize variations from the specific embodiments that will nonetheless fall within the scope of the invention. For example, cost data store 132 may be a centralized database and communications between estimate compilation sub-module 131 and feedback sub-module 133 with cost data store 132 is facilitated via a private and/or public communications network. In this way the accuracy of the cost data stored in cost data store 132 is of a higher accuracy due to a larger base of projects that provide actual cost data feedback to the cost data store.

Additionally, cost data store may be formed from a plurality of data stores with each data store containing therein cost estimates for different countries and different regions within a country. Hence, communications between the estimate compilation sub-module 131 and feedback sub-module 133 with a cost data store will be prefaced by an indication as to the location the construction project is taking place. In this way, the method and system of the present invention accommodates for varying construction costs between regions within a country and indeed between different countries.

Furthermore, the system and method of the present invention provides for differing levels of access for different entities involved in the construction of a building. For example, a sub-contractor may have access to the cost data store of the project entity to determine the amount the project entity has estimated for the materials and labor provided by the sub-contractor and hence the sub-contractor may tender for the job and manage their costs appropriately.

Additionally, the system and method of the present invention provides for the generation of exception reports. If an invoice is received by the project entity from a sub-contractor that diverges from the estimate calculated by the estimation module by a specified factor, the estimation module may generate an exception report for the project entity to follow up this divergence with the sub-contractor to determine the factors that caused this cost divergence.

A skilled person will appreciate that extraction system 120 may operate independently from estimation module 130.

It will be appreciated that various other changes and modifications may be made to the embodiment described without departing from the spirit and scope of the invention.

1. A method of estimating project costs, said method including the steps of:
(i) electronically extracting geometric information from a design plan for said project, said geometric information being formed from one or more elemental building objects with each said elemental building object having one or more associated attributes;
(ii) automatically generating a cost estimate for construction of said design plan using a computerized cost data store containing estimated costs for each said elemental building object electronically extracted in step (i);
(iii) electronically receiving actual cost data relating to each said elemental building object; and
(iv) automatically updating said computerized cost data store based on said actual cost data electronically received.

2. The method of estimating project costs according to claim 1, wherein step (ii) includes the further steps of, for each elemental building object:
(a) calculating a cost estimate using said estimated cost for said elemental building object obtained from said computerized cost data store based on said one or more attributes of said elemental building object; and
(b) saving said cost estimate calculated in step (ii)(a) for said elemental building object.

3. The method of estimating project costs according to claim 2, wherein said cost estimate generated in step (ii) is the sum of all cost estimates saved in step (ii)(a).

4. The method of estimating project costs according to claim 1, wherein said cost estimate generated in step (ii) provides an indication of the cost estimate of each said elemental building object forming part of said design plan.

5. The method of estimating project costs according to claim 1, wherein said actual cost data received in step (iii) is electronically received after completion of said project.

6. The method of estimating project costs according to claim 1, wherein said actual cost data electronically received in step (iii) is received during said project.

7. The method of estimating project costs according to claim 1, wherein said estimated cost of a said elemental building object is replaced with said actual cost in said computerized cost data store in step (iv) when said actual cost of said elemental building object differs from said estimated cost.

8. The method of estimating project costs according to claim 1, wherein said estimated cost of a said elemental building object is replaced with an average of said actual cost and said estimated cost in said computerized cost data store in step (iv) when said actual cost of said elemental building object differs from said estimated cost.

9. The method of estimating project costs according to claim 1, wherein said estimated cost of a said elemental building object is replaced with said actual cost in said computerized cost data store in step (iv) when said actual cost of said elemental building object differs from said estimated cost by a predetermined amount.

10. The method of estimating project costs according to claim 1, wherein said design plan is in the form of an electronic drawing file and each said elemental building object is formed from one or more basic geometric objects.

11. The method of estimating project costs according to claim 10, wherein each said basic geometric object is uniquely identified in step (i) by:
(a) retrieving an identifier of said basic geometric object from said electronic drawing file;
(b) adding said identifier to a unique label for said basic geometric object; and
(c) one or more iterations of determining whether said basic geometric object forms part of a more complex object and, if so:
i. retrieving an identifier of said more complex object; and
ii. adding said identifier of said more complex object to said unique label for said basic geometric object.

12. A system for estimating project costs comprising:
an extraction system for electronically extracting elemental building objects from geometric objects in a design plan; and
an estimation module in communication with said extraction system, said estimation module having:
a computerized cost data store containing cost estimates for each said elemental building object;
wherein, said estimation module automatically provides a cost estimate of said project based on said cost estimates stored in said computerized cost data store of each said elemental building object extracted by said extraction system, and wherein said cost estimates stored in said computerized cost data store in said estimation module is updated upon receipt of actual costs for each said elemental building object.

13. The cost estimation system of claim 12, wherein said actual cost for each said elemental building object is received after completion of said project.

14. The cost estimation system of claim 12, wherein said actual cost for each said elemental building object is received during said project.

15. The cost estimation system of claim 12, wherein said estimated cost for each said elemental building object is updated with said actual cost received.

16. The cost estimation system of claim 12, wherein said estimated cost data for each said elemental building object is updated with said actual cost received when said actual cost data differs from said estimated cost data by a predetermined value.

17. The cost estimation system of claim 12, wherein said estimated cost for each said elemental building object is replaced with an average of said actual cost and said estimated cost.

18. The cost estimation system of claim 12, wherein said design plan is in the form of an electronic drawing file and each said elemental building object is formed from one or more basic geometric objects and wherein said extraction system uniquely identifies each said basic geometric object.

19. A computer program product comprising computer usable medium having computer readable program code embodied therein for estimating project costs, the computer readable program code in said computer program product comprising:
computer readable program code for electronically extracting geometric information from a design plan for said project, said geometric information being formed from one or more elemental building objects with each said elemental building object having one or more associated attributes;
computer readable program code for automatically generating a cost estimate for construction of said design plan using a computerized cost data store containing estimated costs for each said elemental building object electronically extracted computer readable program code for electronically receiving actual cost data relating to each said elemental building object; and
computer readable program code for automatically updating said computerized cost data store based on said actual cost data electronically received.

20. A program storage device readable by a machine, tangibly embodying a program of instructions executable by said machine to perform method steps for estimating project costs, said method steps comprising:
(i) electronically extracting geometric information from a design plan for said project, said geometric information being formed from one or more elemental building objects with each said elemental building object having one or more associated attributes;
(ii) automatically generating a cost estimate for construction of said design plan using a computerized cost data store containing estimated costs for each said elemental building object electronically extracted in step (i);
(iii) electronically receiving actual cost data relating to each said elemental building object; and
(iv) automatically updating said computerized cost data store based on said actual cost data electronically received.
